(19) United States
(12) Patent Application Publication
(10) Pub. No.: US 2006/0036513 A1
(43) Pub. Date: Feb. 16, 2006

(54) System and method for providing property improvements

(76) Inventors: Jerry Whatley, Tooele, UT (US); Glade Jones, Salt Lake City, UT (US)

Correspondence Address: THORPE NORTH & WESTERN, LLP., 8180 SOUTH 700 EAST, SUITE 200, SANDY, UT, 84070, US

(21) Appl. No.: 11/187,591

(22) Filed: Jul. 22, 2005

Related U.S. Application Data
(63) Continuation-in-part of application No. 09/964,037, filed on Sep. 26, 2001.

(51) Int. Cl. G06Q 30/00

(52) U.S. Cl. 705/27; 705/26; 705/37

(57) ABSTRACT

A system and method are provided for improving a property that has been offered for sale. The method includes the operation of attracting property purchasers to a website by offering a real estate marketing service to property sellers on the website. An electronic graphical plan of the property for use on the website can also be generated. Another operation is enabling the property purchaser to place and position graphic objects representing one or more property improvements onto the electronic graphical plan on the website. These one or more property improvement objects can also be offered for sale through the website. A further operation is financing a purchase of one or more property improvements represented by the graphic objects using financing available through the website.

This patent application claims priority to U.S. Provisional Patent Application Ser. No. 60/235,518 filed Sep. 26, 2000 and is a Continuation-in-Part of U.S. patent application Ser. No. 09/964,037, filed on Sep. 26, 2001 entitled “METHOD AND SYSTEM FOR PROVIDING REAL ESTATE SERVICES USING A GLOBAL NETWORK”.

### FIELD OF THE INVENTION

The present invention relates generally to improving property, buildings, and dwellings located on the property.

### BACKGROUND

Purchasing a home can be a time consuming and grueling experience. Whether a potential home buyer is a first time purchaser or a purchaser upgrading to a bigger and better home, it can take months of searching and looking to find the perfect home.

Recently, the Internet has provided valuable tools to enable the potential home buyer to narrow and refine their search. Using search sites available on the Internet, the buyer can narrow their search electronically using a variety of predetermined real estate constraints, such as geographic location, size, age, cost, and type of home or property the buyer is searching for. The buyer can even view pictures of both the exterior and interior of many homes which are now listed on Internet sites. Some advanced sites even enable buyers to take virtual tours of listed homes, with 360 degree views of many of the rooms. With all of the available information, the buyer can have a good idea of which homes he or she is actually interested in, drastically reducing the amount of time spent physically touring listed homes.

Once a buyer has found a home he or she is interested in purchasing, it can take several weeks or even months to actually purchase the home and move in. During this time, access to the home can be limited. Each time the buyer wants to see the home they typically have to contact their realtor, who in turn must contact the seller or the sellers' realtor to obtain permission to see the home. The difficulty in obtaining access to the home during the purchasing period can significantly reduce the amount of time which the buyer has to make any changes to the home before moving in.

Naturally, most buyers desire to personalize the home that they are purchasing. The carpet or the walls may not be the colors that the buyer would like. Sometimes larger changes, such as updating the kitchen, or remodeling a room are desired. Often, the buyer wishes to purchase new furniture or appliances for their new home. Before new furniture or appliances can be purchased, the places where they will be placed are typically carefully measured. Before new carpet or paint can be bought, existing colors within the home are usually researched. These updates, changes, and purchases can all require repeated visits to the home to ascertain the interior decor, dimensions, and layout of the home. However, the repeated visits can be difficult to arrange due to the number of people which may be involved in arranging the visit. This can make updating and remodeling the new home, and purchasing new furniture for it, a difficult task to accomplish prior to completing the purchase of the house.

Even when remodeling or redecorating can be accomplished as the buyer is moving in, it can be difficult for the home buyer to pay for the improvements. Purchasing a home can be extremely expensive, with realtor fees, financing costs, moving costs, and cleaning costs often consuming much of the home buyer's savings. Little money may be left over for the desired remodeling or redecorating. After moving in, it can become even more difficult to accomplish the desired remodeling and redecorating, because the buyer's furniture and belongings have been placed throughout the house. Therefore, it can be beneficial to perform as much remodeling and redecorating as possible prior to the home buyer moving in.

### SUMMARY

A system and method are provided for improving a property that has been offered for sale. The method includes the operation of attracting property purchasers to a website by offering a real estate marketing service to property sellers on the website. An electronic graphical plan of the property for use on the website can also be generated. Another operation is enabling the property purchaser to place and position graphic objects representing one or more property improvements onto the electronic graphical plan on the website. These one or more property improvement objects can also be offered for sale through the website. A further operation is financing a purchase of one or more property improvements represented by the graphic objects using financing available through the website.

### BRIEF DESCRIPTION OF THE DRAWINGS

Additional features and advantages of the invention will be apparent from the detailed description which follows, taken in conjunction with the accompanying drawings, which together illustrate, by way of example, features of the invention, wherein:

FIG. 1 is a flow chart depicting an embodiment of a method for improving a property that was recently put up for sale;

FIG. 2 illustrates a website offering a real estate marketing service to property sellers;

FIG. 3a illustrates the website depicting an electronic graphical floor plan of a main floor of a dwelling on the property;

FIG. 3b illustrates a close-up of the floor plan of FIG. 3a further showing links to show a virtual tour of selected rooms.

FIG. 3c illustrates a panorama viewer for viewing a virtual tour;

FIG. 4a illustrates the website depicting a graphic object display area for selecting graphic objects and dragging them onto the floor plan;

FIG. 4b illustrates the floor plan having a plurality of graphic objects placed about the floor plan;

FIG. 5a illustrates a website depicting a color palette used to display virtual paint colors;

FIG. 5b illustrates the website depicting a photo viewing window which can enable a user to virtually paint a dwelling area by dragging colors from the color palette of FIG. 5a onto surfaces of the dwelling area displayed in the photo viewing window;

FIG. 5c illustrates the website depicting a selection of colors and/or types of carpeting; and

FIG. 6 illustrates a financing information window to enable a user to transmit information electronically for financing products and services to improve the property.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

Previously, potential property purchasers have typically faced significant limitations during the time period between deciding to buy the property and actually relocating to the property. It can be difficult to obtain entrance to the home to view the layout, styles, and colors throughout the home. The buyer may need such knowledge to obtain new furnishings and decorations, as well as to make changes and improvements to the home. Often, several visits are necessary when making detailed decisions. While this time period is often the most challenging time to view the home, it can also be the most efficient time for the property purchaser to make any desired changes to the home and purchase new furniture and decorations.

Several embodiments of the present invention are disclosed which provide a system and method for a property purchaser to obtain the desired information about the buyer's new property, and any dwellings thereon, while minimizing inconvenience to the previous owner and/or realtor(s). The system and method can provide financing means to enable the property purchaser to quickly and simply obtain additional financing for decorating, improving, and furnishing dwellings such as a home or business.

As used herein, the term property purchaser refers to one or more persons who are interested in purchasing a property. The property may have one or more buildings or dwellings located thereon. The term property purchaser can include persons who have recently purchased a home or business, as well as persons who are actively seeking to purchase a home or business but have not yet completed the purchase. Thus, the term is not meant to be limiting to persons who have legally purchased a new property or home. Further, the term is not meant to be limiting to persons purchasing a primary residence. The term property purchaser is also meant to be inclusive of persons who are purchasing a vacation home, multiple homes for business or leisure needs, or even an office building or a portion of an office building. The property can also have a factory building or a warehouse building located thereon. The home may be a house, an apartment, a duplex, a condominium, town house, loft, or any other type of residential dwelling.

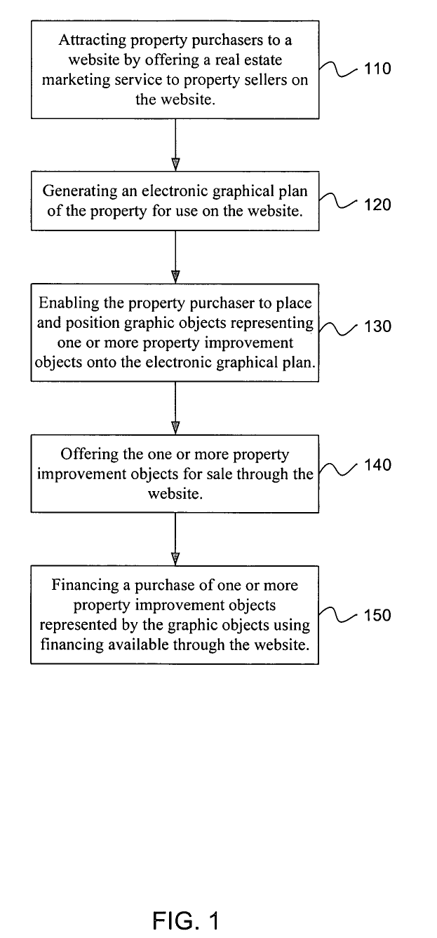

One embodiment of the present invention provides a method for improving a property that has been offered for sale or sold, as shown in the flow chart in FIG. 1. The property can include both raw land, developed land, and/or land having buildings thereon. The term “offered for sale” is intended to mean a property which has been listed for sale, either by an agent or by the property owner. The method can include the operation of attracting property purchasers to a website by offering a real estate marketing service to property sellers on the website, as shown in block 110. The real estate marketing service can comprise a website designed to show a property that has been listed for sale.

A further operation involves generating an electronic graphical plan of the property for use on the website, as shown in block 120. The electronic graphical plan can include a graphical plan of the land, and/or a graphical plan of any dwellings on the property. For example, the electronic graphical plan may include an outline of a residential lot, as well as a floor plan showing a main floor, an upstairs floor, and/or a basement of a residential home.

In order for the electronic graphical plan to be generated, actual measurements at the property location may need to be made. These measurements can be made at the time when the marketing materials for the property are generated. For example, still photos, 360 degree views, video walk-throughs and similar materials can be created for the web page marketing the property. When the photographer, who takes the marketing pictures and video, is on the property, then it is a straight forward matter to take laser measurements or mechanical measurements of the rooms that are visited and photographed. Alternatively, the graphical property plan can be generated by obtaining an actual floor plan of the house created by an architect or other designer. This floor plan can then be digitized or entered using room measurements to provide a usable graphical plan for use on the web page.

In another embodiment, the property may have a small business building on the property. In a further embodiment, the graphical plan may represent a portion of a building, such as an area of a multi-story office building. The graphical plan can include a plan showing the property, including such things as parking areas, as well as a floor plan of the building, including possible subdivisions which can be accommodated within the building for various businesses to coexist. Alternatively, if there are no dwellings on the property, the graphical plan may merely be a graphical display portraying the approximate dimensions of the property.

A further operation involves enabling the property purchaser to place and position graphic objects representing one or more property improvement objects onto the electronic graphical plan, as shown in block 130. The web interface can enable the property purchaser to move and position graphic objects (i.e., drag and drop) representing one or more property improvement objects onto the electronic graphical plan on the website. The property improvement objects can be graphic objects which can represent any type of object that can be purchased to improve the property. For example, the graphic object can represent a furnishing, an electronic device, an appliance, a fixture such as a light, fan, window, or door, artwork, home decorations, office furniture, structures such as homes or buildings, outdoor products such as a grill, hot tub, trampoline, playground equipment, plants and vegetation, or any other type of object which can improve a property. The graphic objects can be electronically represented to be displayed on the website with substantially correct dimensions relative to the electronic graphical plan.

For example, in the embodiment where the property is a residential property or home, the graphic objects can include furniture and decorating objects for the interior of the home and typical objects for the garage such as motorized vehicles, boats, RVs, work benches, etc. The graphic objects may represent actual objects, such as a specific piece of furniture, or a plurality of graphic objects may be designed to generically represent classes of objects, such as couches, tables, beds, benches, entertainment centers, mirrors, lamps, etc. The graphic objects will be discussed more fully below.

Another operation involves offering the one or more property improvement objects for sale through the website, as shown in block 140. A further operation involves facilitating the property purchasers' financing and purchase of one or more property improvements represented by the graphic objects using financing available through the website, as shown in block 150. The financing will be discussed more fully later.

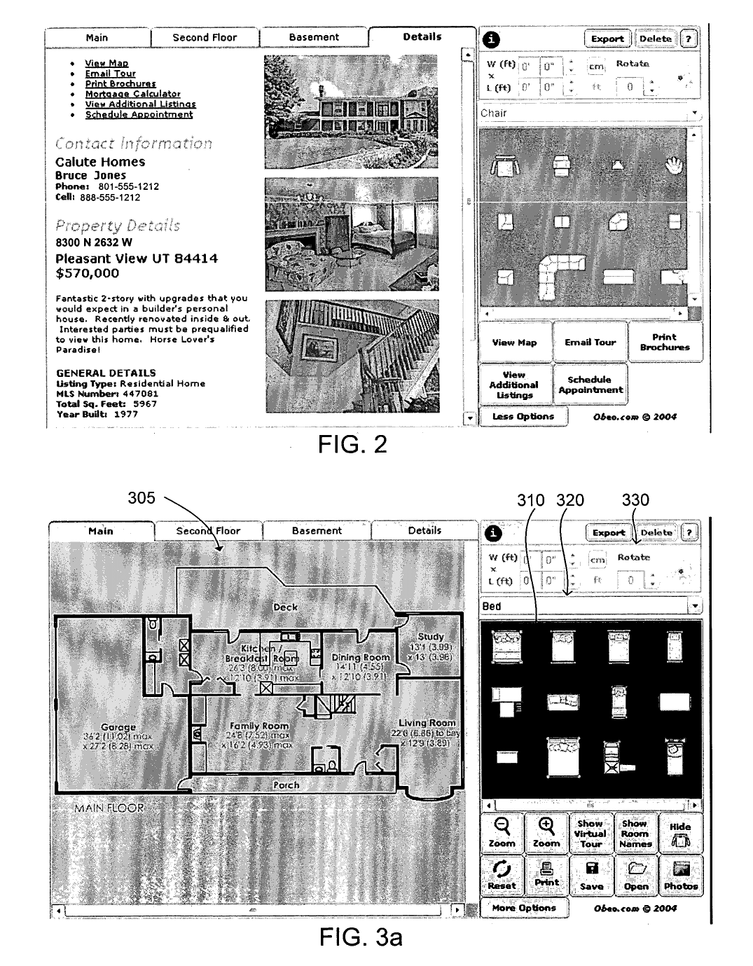

One embodiment of the website is shown in FIG. 2. The website is shown having tabs for “details” about a property as well as each floor of a residential home. Of course, any type of layout may be used which enables a viewer of the website to view the property. In this embodiment, a details tab, as shown in FIG. 2, can be used to display pictures of the property, and to provide a summary of details, such as contact information, the address of the property, a short synopsis of the property, as well as details such as the type of property, a listing service number if the property is listed by a realty service, the size of the dwelling, and the year the dwelling was constructed. Other details may also be provided depending upon the type of property.

Additional information on the property can be obtained by clicking buttons in the website. For example, a map showing the location of the property can be obtained. A tour of the dwelling, using the website, can be emailed to other people, such as friends or family. A brochure of the property can be created and printed. An appointment to see the property can be setup, or additional properties can be viewed. Other buttons having additional features can also be incorporated into the website.

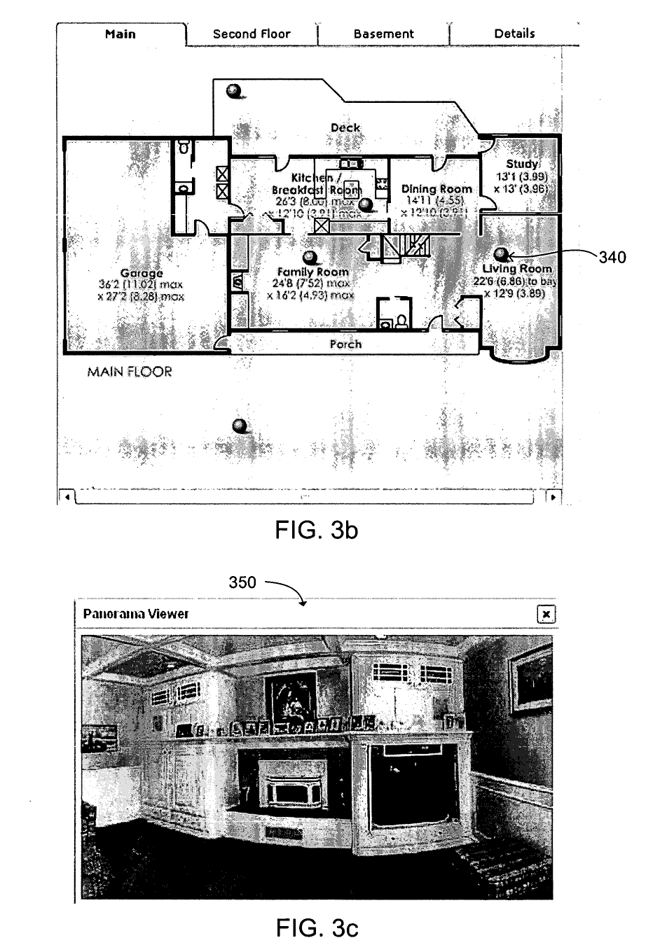

FIG. 3a shows the display of FIG. 2 with the “Main” tab selected. Clicking on the main tab enables a user to view an electronic graphical plan area 305 of the main floor of the home shown in the details tab. The electronic graphical plan area can include a floor plan of the selected floor. The floor plan can be used to provide information to enable the website user to understand the layout and dimensions of the dwelling. The graphical floor plan can also include a property outline in one embodiment, enabling the user to see the size and location of the dwelling with respect to the property. A tab, or electronic graphical floor plan, can be added for each level or room of a dwelling. Additional tabs having graphical floor plans can be used for outbuildings which are not connected to the main dwelling, such as an unattached garage, guest house, or a separate dwelling located on the property.

A graphic object display area 310 is shown having a plurality of different property improvement objects. The property improvement objects are graphic objects, each object representing a potential property improvement. The graphic objects can be sorted into a variety of different categories 320, which can be selected with a drop down box. For example, the graphic objects may be sorted according to their furniture type, function, or room location. For example, categories can include bathroom, beds, bedroom, chairs, children, exercise, family room, garage, kitchen, dining room, laundry, storage, miscellaneous, outdoor, and recreational room. The selection in FIG. 3a shows a category of graphic objects arranged according to furniture type, specifically beds. A variety of different types of beds are shown. When a graphic object is selected the object can be highlighted and the selected object's dimensions can be displayed in a dimension area 330. The dimension area can enable a user to make the graphic object appear larger or smaller with respect to the graphical floor plan 305, or rotate the graphic object. The graphic object can be dragged from the object display area 310 onto the floor plan to a desired location.

Additional features of the website include a reset button to reset the floor plan to its original size and configuration and a print feature that can enable a user to send the floor plan to a printer. The printed copy can include any changes made to the floor plan, such as the addition of graphic objects. Additionally, the floor plan as altered can be saved. A previously saved floor plan can be opened by selecting the open button and selecting a saved floor plan. Traditional photographs of the rooms can also be displayed to enable the user to have a better understanding of what furniture the user may desire to put within the room, or any changes the user may desire to make to the rooms.

A number of other features are also included in the example embodiment of FIG. 3a. The user can zoom in on the graphical floor plan to see certain areas better, or zoom out to obtain a view of the entire floor. The “Show Virtual Tour” button enables links 340 to be displayed in areas of the graphical floor plan, as shown in FIG. 3b. The links can be used to start a viewer showing 360 degree pictures of the rooms. Clicking on the links can enable a window to be displayed which allows a user to view the room, either in a single 360 degree format, or more preferably, in a photo sized format with the ability to pan to the left, right, up, or down to take a virtual tour of the area photographed.

For example, clicking on the link 340 (FIG. 3b) in the family room can enable a panorama viewer window 350 to be displayed, as shown in FIG. 3c. The panorama viewer window can enable a user to view a 360 degree view of the family room. In one embodiment, the window can display a predetermined portion of the room, such as a 90 degree portion of the room. A 360 degree view of the room can pan through the viewer window at a predetermined rate. The user can speed up, slow down, stop, or change directions of the panning view. This gives the perception to the user of virtually being within the room. Thus, a user can take a virtual tour of a room to assist in deciding what types of furniture or improvements the user might prefer within the room.

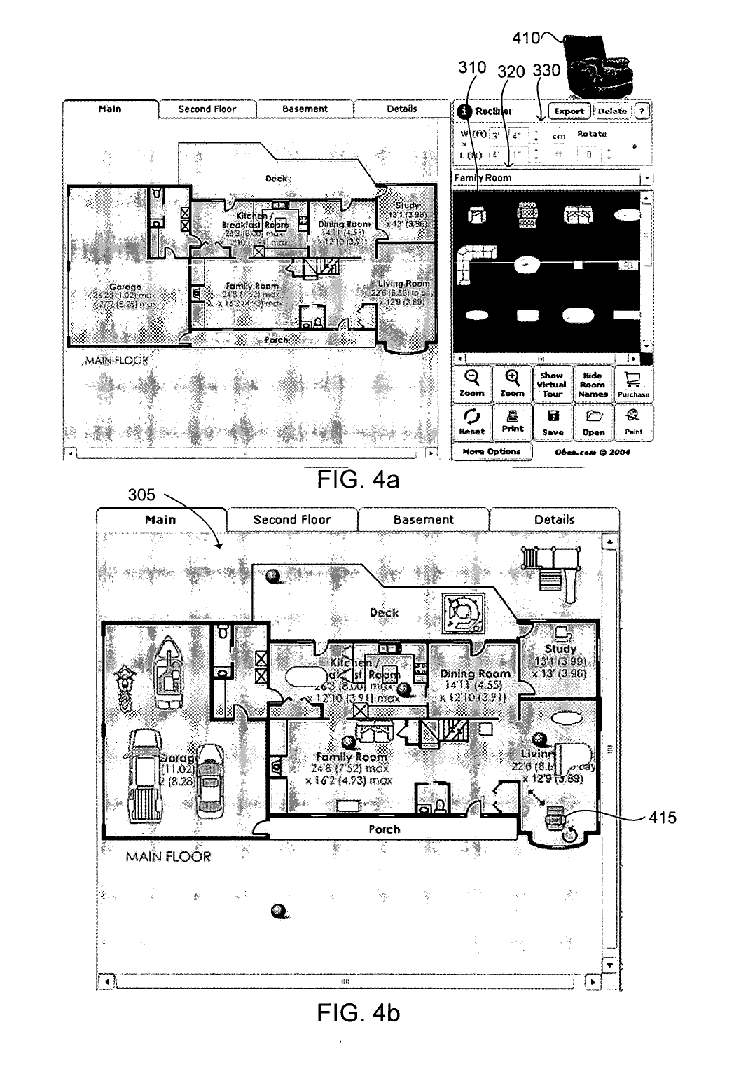

FIG. 4a shows the category 320 of selected graphic objects as the family room. The graphic object display area 310 shows graphic objects which a user may desire to place within a traditional family room. A recliner is highlighted within the display area, and a picture or photo of the recliner 410 is shown above the display area. The picture enables a user to have a better understanding of what the simple graphic object outline within the graphic object display area is supposed to represent. Each of the graphic objects shown within the display area can have an associated picture which can be exhibited above the display area when the graphic object is selected.

One or more graphic objects can be selected using a mouse. Each graphic object that the user would like to place within the floor plan can be dragged onto the graphical floor plan area 305, as shown in the example embodiment of FIG. 4b. The graphical floor plan area shows a variety of graphic objects that have been selected from the graphic object display area 310 (FIG. 4a) and dragged to a desired location within the floor plan. As each graphic object is placed within the floor plan area, the graphic object can be resized and rotated using either the mouse or by entering the desired dimensions and angle of rotation in the dimension area 330 (FIG. 4a).

By sizing each of the graphic objects appropriately with respect to the dimensions of the rooms in the graphical floor plan area 305, a user can determine whether selected furnishings will fit as desired within the building displayed in the floor plans. Graphic objects can also be placed in the yard and the garage. For example, FIG. 4 shows graphic objects representing a truck, car, boat, and motorcycle placed in the garage. A graphic object representing a hot tub is placed on the back deck, and a swing set is located in the backyard next to the hot tub. The ability to place graphic objects representing furnishings and decorations throughout the graphical floor plan enables the user to determine how the objects will fit within the house without actually having to visit the house and make measurements. This can save countless hours for the seller, the purchaser, and any realtors which may be involved. In addition to enabling the user to measure the property for furnishings, the website can also be used to plan changes in appearance of the home and property.

As previously mentioned, physical changes to a property can be accomplished prior to moving in. However, it can be difficult to gain access to the property to obtain the necessary information for making decisions such as paint color, carpet selection, window type, and other decisions regarding the property and any structures which may be located on the property. Using the website, a user can be enabled to view the property and any structures located on the property. The user may view the property using static pictures as well as 360 degree pictures, enabling the user to pan around an entire room or location within the structure. The website can be configured to enable the user to make virtual changes to one or more colors of paint on the walls.

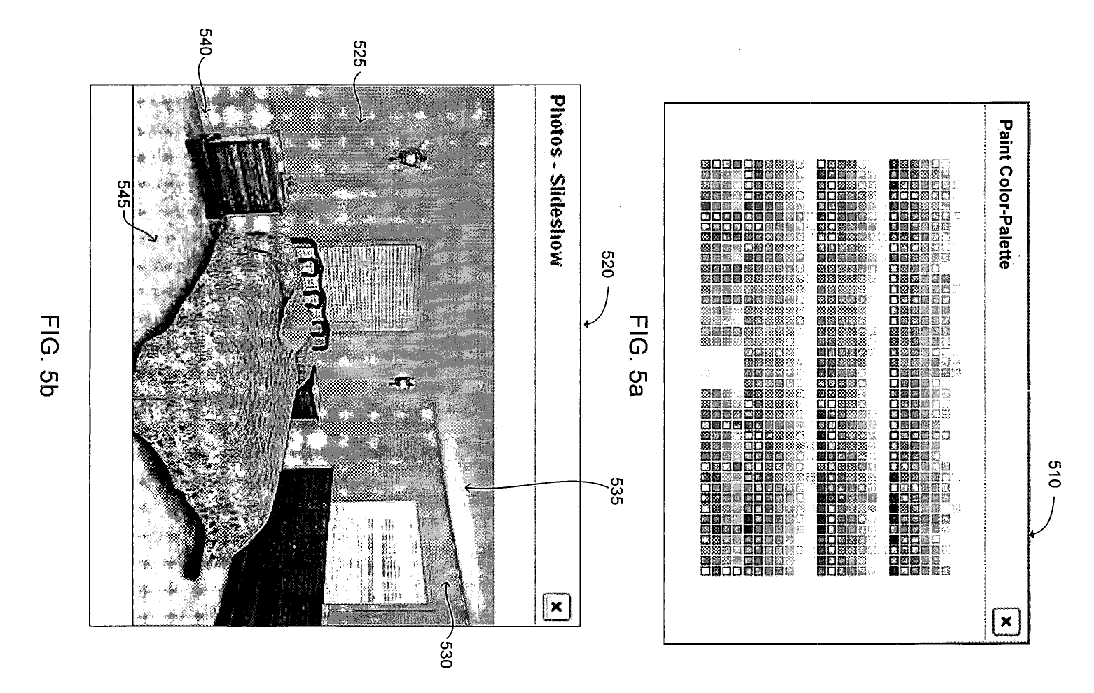

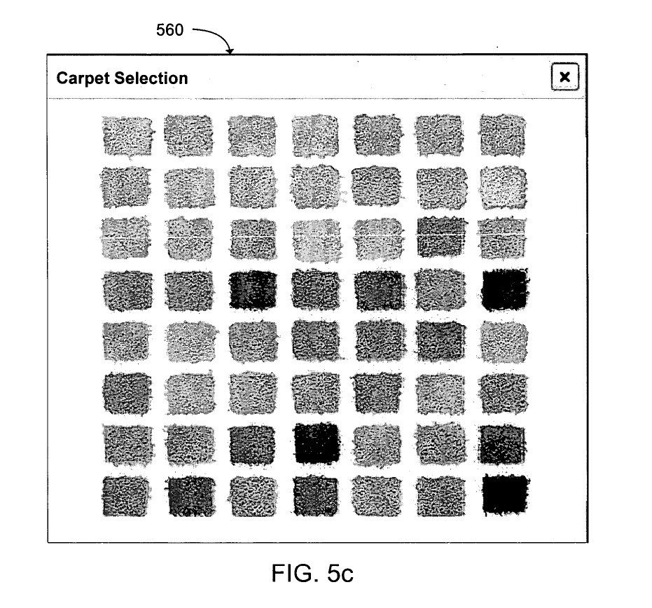

In one embodiment, the user can click on the paint button (see FIG. 4a) to enable a paint color palette window 510 to be displayed and a picture display window 520 showing a picture of an area inside a structure, such as a house, as shown in FIGS. 5a and 5b. The paint color palette may be designed to include paint colors produced by one or more paint suppliers. The picture in the display window can be configured to include separate paintable areas. Paintable areas are surfaces which can be colored with the paint colors from the palette. The areas can be outlined using software to designate each paintable area. This software may be available to the user to outline the area to be painted or have floor covering. Alternatively, individuals hired by the website owner can be requested to outline the area of pictures at the request of someone interesting in purchasing pain and floor coverings. The paintable areas may be as simple as one area that includes every wall and ceiling in the picture, or a paintable area may be a single surface or type of surface such as a ceiling area, separate wall areas, a trim area, a floor area, etc. Each picture in the display window may contain a plurality of paintable areas.

The user can then select a specific color within the palette 510 and drag the color to a paintable area. The color of the paintable area can then be updated in the picture display window 520 so that the area appears to be painted the color selected from the palette. For example, a first color can be selected for the first wall 525 and second wall 530. A second color can be selected for the ceiling 535. If desired, a different color can be selected for the trim 540. A user can use the website to determine which colors of paint to purchase without actually visiting the property.

Similarly, carpet can be selected by using a carpet selection window 560 (FIG. 5c) which can be used to display a variety of different types and colors of carpeting. A user can drag and drop carpet samples into a room in the picture display window 520. The carpet 545 in the picture can be updated to enable the carpet in the picture to appear substantially similar to the carpet in the sample. Other types of flooring, such as marble, wood, laminate, tile, and linoleum may also be selected and virtually applied to a floor in the picture display window.

Additional changes can also be made using the picture display window 520. For example, windows or window coverings can be virtually selected and applied to a house, allowing a user to select new windows or purchase window coverings before moving into the house. New light fixtures can also be selected and virtually dropped into the picture. Paintings and art can also be virtually applied to the picture. Entire walls may even be changed or moved, allowing a user to see how the house may look after being remodeled.

Alternatively, the simple two dimensional floor plan in FIGS. 4a and 4b can be made into three dimensional floor plans (not shown). A website user can then travel through the house in a similar fashion to a video game, enabling the user to take a virtual tour of each room shown in the floor plan. The three dimensional floor plan can be configured to enable the user to place graphic objects throughout the room representing furnishings and decorations. The color palette can be used to apply virtual paint to the surfaces of the rooms. Carpet samples can be used to enable the user to select different types of carpet for each room. Thus, the three dimensional floor plan can be used in a similar fashion to the two dimensional floor plan in conjunction with the panorama viewer window 350 (FIG. 3c), picture display window 520 (FIG. 5b), paint color-palette window 510 (FIG. 5a), carpet selection window 560 (FIG. 5c), and other windows which may be used to select virtual products to apply to the picture display window.

In one embodiment, the website may be linked to other websites to enable the user to select desired furnishings, decorations, paint, windows, doors, carpet, and other products and services needed by the user to alter, furnish, decorate, and update the property as desired. Services can include carpet layers, painters, interior decorators, landscapers, and other service persons needed to decorate and update the property. Once the desired products and services have been selected, they can be purchased by clicking on the purchase button (FIG. 4a).

As previously discussed, the cost of the products and services can be expensive. Unfortunately, the property purchaser may have minimal liquid assets with which to buy the products and services after purchasing the property. While most of the products and services can be purchased on store credit or through a credit card, the financing costs can be quite high, typically well above 10% per year and often above 20%. Financing costs alone for $10,000 worth of products and services can cost over a thousand dollars per year.

One option available to a property purchaser is to have a mortgage broker include a certain amount for the products and services in the mortgage for the property. However, a 15 year loan, and especially a 30 year loan can cost the purchaser a substantial amount of the life of the mortgage. A 30 year mortgage typically costs at least three times the amount loaned. Thus, the purchaser would end up spending $30,000.00 over 30 years to pay for $10,000 worth of products and services. Therefore, there is a need to provide the property purchaser with a less expensive and convenient means for financing the purchase of the products and services used to update the property.

In order to enable users to purchase the products and services selected using the website, financing can be obtained by clicking on the purchase button (see FIG. 4a). The term financing, as used in the present invention, can be defined as the means for obtaining a loan for a period of at least 6 months. Financing can be provided through the website by contracting with mortgage brokers or other lenders that can provide favorable lending rates. Alternatively, the website owners may provide direct financing. Favorable rates for the property purchaser can be obtained through the lender's knowledge that the property purchaser's real estate can be provided as collateral for the financing. The financing can provide substantial savings to the user through reduced interest rates and loan length.

For example, the financing may be provided through a home equity loan to the user. The home equity loan can provide the user a financing option with an interest rate which may be substantially lower than financing obtained through consumer goods stores. The loan period may be from 6 months to 30 years, but is preferably less than 15 years.

Even in the situation where the financing provided is similar in cost to other financing options, the present embodiment provides a convenient method for viewing products that the property purchaser wants to buy. These products can be viewed in the context of the graphical plan of the building or home. Then the property purchaser can immediately finance the items that are purchased. This method allows the user to visualize products in their home (or business) interior and then immediately purchase the items under financing terms that are obtained through the website.

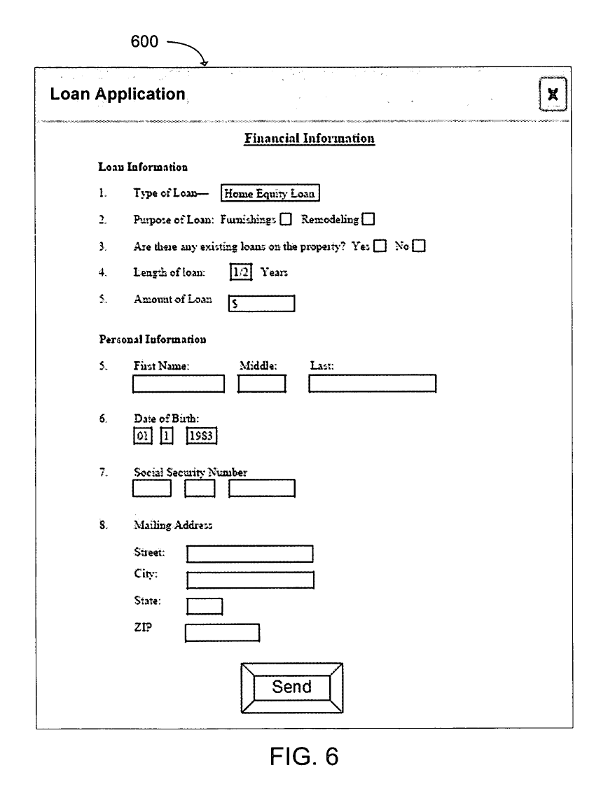

In one embodiment, clicking on the purchase button (FIG. 4a) can enable a financing information window 600 to pop up, as shown in FIG. 6. The financing information window can contain one or more pages of questions for a property purchaser to obtain financing to pay for the products and services used to improve the property. The window can include areas for the purchaser to enter data that can be sent to preferred lenders. The preferred lenders can provide the financing to the property purchaser.

For example, the form may ask for information concerning the type of loan, the purpose of the loan (i.e. the type of goods and services to be paid for with the loan), whether there are any existing loans on the purchased property, the desired length of the loan, personal information such as name, address, citizenship, age, contact information, the purchaser's social security number, and any other information deemed necessary for a preferred lender to obtain financing for the purchaser. The information can then be electronically transmitted by the purchaser to the preferred lender through the website and arrangements can be made to enable the lender to offer the purchaser financing.

The financing options can include, but are not limited to, a home equity loan, a second mortgage, a home equity line of credit, signature loans, and other types of financing which can provide the property purchaser with a lower interest rate than provided by consumer stores. In another embodiment, the financing can be obtained for products and services for the purchased property that are obtained from one or more locations that are not affiliated with the website.

In a further embodiment the property may contain an office building. Alternatively, the website may be used to show a portion of an office building, such as a specific office area in a high rise building. Floor plans for the office building, or a portion of the office building, can be displayed, as previously disclosed. Those seeking to rent or purchase office space can view the floor plan, divide up the office space as desired, and place virtual office furniture such as desks, computers, and partitions throughout the floor plan. Changes desired in the office area, such as new paint and carpet, can also be virtually viewed as discussed above.

Desired products and services can then be purchased and financing can be obtained. Alternatively, financing may be obtained for the purchase of products and services from external providers not affiliated with the website. Thus, an office manager seeking to find new office space can use a single website to substantially reduce the amount of time and the number of visits to the office building that the office manager would have needed to get the office ready for employees or business operations.

In another embodiment, the website can be used to display a property that does not have any permanent dwellings located on the property. In this embodiment, the graphic object display area 310 (FIG. 3) can be used to display different types and shapes of buildings. For example, the graphical plan area 305 may be used to display the shape of a residential lot having a size of ⅓ acre. A property purchaser can view the property, the location using the map button, and other attributes of the property. The property purchaser can then select a graphic object having a shape substantially similar to a house that the property purchaser desires to build. The dimensions of the graphic object representing the house can be altered to be substantially correct and the graphic object can be rotated to fit as needed on the property. The property purchaser can use the website to determine whether the house will fit correctly on the property. Other types of graphic objects can also be placed on the lot, such as outdoor objects like a trampoline, swing set, hot tub, and even gardens. The website can enable the property purchaser to make an informed decision as to whether to build the property on the selected lot.

The internet has provided a tool to substantially reduce the amount of time spent searching for a house or other property. However, once a home or property is purchased, the time savings provided by internet access and advertising typically ends. The present invention enables a property purchaser to obtain knowledge and details of the property which can otherwise only be obtained through repeated trips to the purchased property. The property purchaser can be assured that furniture, decorations, and improvements to the property will fit and appear as desired. Financing can be obtained which can reduce the amount of interest paid to obtain the products and services to improve the property as desired.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A method for improving a property that has been offered for sale, comprising the steps of:
attracting property purchasers to a website by offering a real estate marketing service to property sellers on the website;
generating an electronic graphical plan of the property for use on the website;
enabling the property purchaser to place and position graphic objects representing one or more property improvement objects onto the electronic graphical plan;
offering the one or more property improvement objects for sale through the website; and
financing a purchase of one or more property improvement objects represented by the graphic objects using financing available through the website.

2. A method as in claim 1, further comprising enabling a user to obtain financing for property improvements through the website, wherein the financing is selected from the group consisting of a second mortgage, a home equity loan, and a home equity line of credit.

3. A method as in claim 1, further comprising enabling a user to obtain financing for property improvements through the website, wherein the financing period is for a term of at least 6 months and not more than 15 years.

4. A method as in claim 1, wherein financing a purchase further comprises displaying a financing information window configured to enable a user to transmit information to one or more preferred lenders.

5. A method as in claim 4, further comprising transmitting sufficient information to one or more preferred lenders to enable the one or more preferred lenders to determine whether to offer financing to the user.

6. A method as in claim 1, further comprising enabling a user to obtain financing for property improvements, wherein the property improvements comprise products and services purchased to improve the property.

7. A method as in claim 1, wherein the property is selected from the group consisting of undeveloped property, developed property, property having a single dwelling, and property having multiple dwellings.

8. A method as in claim 7, wherein the dwelling can be selected from the group consisting of a house, a duplex, a town house, a condominium, an apartment, a loft, a trailer, an office building, a warehouse, and a factory building.

9. A method as in claim 1, wherein the step of generating an electronic graphical plan further comprises generating a graphical plan comprising a graphical layout of a predetermined area of a building.

10. A method as in claim 7, wherein the step of generating an electronic graphical plan further comprises generating a graphical plan wherein separate graphical floor plans are generated for each level of a dwelling.

11. A method as in claim 1, wherein the property improvement object is selected from the group consisting of a furnishing, an electronic device, an appliance, a fixture, a light, a fan, a window, a door, a motorized vehicle, exercise equipment, artwork, a home decoration, office furniture, a home, a building, an outdoor product, a grill, a hot tub, a trampoline, playground equipment, a tree, outdoor plants, and indoor plants.

12. A method as in claim 1, further comprising organizing the graphic objects into groups that can be selected by the property purchaser.

13. A method as in claim 1, further comprising enabling the graphic objects to allow the property purchaser to select one or more graphic objects and drag the selected graphic objects to a desired location onto the electronic graphical plan.

14. A method as in claim 1, further comprising configuring the graphic objects to enable the property purchaser to scale the graphic objects with respect to the electronic graphical plan.

15. A method as in claim 1, further comprising configuring the graphic objects to enable the property purchaser to rotate the graphic objects with respect to the electronic graphical plan.

16. A method as in claim 1, further comprising displaying a picture associated with a selected graphic object, wherein the picture displays the property improvement represented by the selected graphic object.

17. A method as in claim 1, further comprising configuring the electronic graphical plan to include one or more links comprising a 360 degree picture of an area within the electronic graphical plan.

18. A method as in claim 1, further comprising providing links to other websites to enable a user to select desired property improvements from websites offering the property improvements.

19. A method for improving a property that has been offered for sale, comprising the steps of:
attracting property purchasers to a website by offering a real estate marketing service to property sellers on the website;
generating an electronic graphical plan of the property for use on the website;
enabling the property purchaser to select a color on a color palette having a plurality of colors and apply the selected color to one or more surfaces in an image of a portion of a room;
enabling property purchaser to buy a surface covering in the color selected from the color palette; and
financing a purchase of the surface covering using financing available through the website.

20. A method as in claim 19, further comprising displaying a paint color palette window having a plurality of colors wherein the plurality of colors are associated with colors of paint.

21. A method as in claim 19, further comprising applying the selected color to one or more surfaces in a static picture or 360 degree picture of the room.

22. A method as in claim 19, further comprising displaying a flooring selection window configured to enable a user to select a flooring sample from the flooring selection window having a plurality of colors and types of flooring and applying the selected flooring sample to one or more surfaces in a picture of a portion of the room.

23. A method as in claim 22, further comprising applying the flooring sample to a surface of the dwelling, wherein the surface is comprised of a floor area in the picture of a portion of the dwelling.

24. A method as in claim 22, further comprising applying a flooring sample wherein the flooring is selected from the group consisting of carpet, marble, wood, laminate, tile, and linoleum.

25. A method as in claim 19, further comprising configuring a picture viewer to enable a user to apply one or more improvement objects to one or more surfaces in a picture of a portion of the room displayed in the picture viewer.

26. A method as in claim 19, further comprising displaying the electronic graphic plan as a three dimensional model of the property configured to enable a user to walk through the property and any buildings located on the property.

27. A method as in claim 26, further comprising enabling the user to apply improvement objects to surfaces of the three dimensional model, wherein the improvement objects are selected from the group consisting of a window, a window covering, a picture, a decoration, a door, a light fixture, a fan, a wall, paint, wallpaper, carpet, marble, wood, laminate, tile, and linoleum.

28. A program storage device readable by a machine, tangibly embodying a program of instructions executable by the machine to perform method steps for improving a property that was recently offered for sale, said method steps comprising:
attracting property purchasers to a website by offering a real estate marketing service to property sellers on the website;
generating an electronic graphical plan of the property for use in advertising the property for sale;
posting the electronic graphical plan on the website;
enabling the property purchaser to place and position graphic objects representing one or more property improvements onto the electronic graphical plan on the website;
offering the one or more property improvement objects for sale through the website; and
facilitating the property purchaser to purchase one or more property improvements represented by the graphic objects using financing available through the website.
